(19) United States
(12) Patent Application Publication
(10) Pub. No.: US 2015/0315709 A1
(43) Pub. Date: Nov. 5, 2015

(54) MANUFACTURING METHOD OF TEST STRIP

(71) Applicants: KO-JU CHEN, Changhua County (TW); CHUN - KAI WANG, New Taipei (TW)

(72) Inventor: CHUN - KAI WANG, New Taipei (TW)

(21) Appl. No.: 14/667,932

(22) Filed: Mar. 25, 2015

(30) Foreign Application Priority Data
May 1, 2014 (TW) 103115712

(51) Int. Cl. C23C 18/16; C23C 18/31; C23C 18/40; C23C 18/34; G01N 27/327; C23C 18/44

(52) U.S. Cl. CPC C23C 18/1651; G01N 27/3272; C23C 18/1605; C23C 18/44; C23C 18/40; C23C 18/34; C23C 18/31; C23C 18/1641

(57) ABSTRACT

A manufacturing method including the steps of: providing a substrate, whereby a masking layer is formed on one surface of the substrate; carrying out a patterning manufacturing process, whereby a patterning is formed on the masking layer, and a section covered with the masking layer and an exposed section not covered with the masking layer are formed on the surface of the substrate; forming an ion guide on the surface of the exposed section of the substrate; carrying out a first chemical plating, whereby a first metal layer is formed on the surface of the ion guide; stripping the masking layer, whereby the masking layer is removed from the surface of the substrate; carrying out a second chemical plating, whereby a second metal layer is formed on the surface of the first metal layer, which is used to form a line metal patterning, and thus producing a test strip.

### BACKGROUND OF THE INVENTION

(a) Field of the Invention

The present invention relates to a manufacturing method of test strip, and more particularly to a manufacturing method for the simple and convenient manufacturing of test strips provided with metal electrodes.

(b) Description of the Prior Art

The advancement of technology has brought about a continuous increase in people's life expectancy, with acute infectious diseases chronic diseases gradually being replaced by chronic diseases. And these types of diseases have now become one of the main causes of death in people, among which, diabetes is the chronic disease with the highest morbidity rate in people.

Without a method for early diagnosis of diabetes, and not receiving treatment in the early stages of the disease, diabetes brings about many complications such as: retinopathy, neurological and vascular disorders, and nephropathy, which can lead to blindness, amputation, hypertension, stroke, and even death. Hence, long-term regular follow-up and management of a patient's blood glucose and blood pressure to control a patient's diabetes condition and further prevent or retard the occurrence of other complications have become extremely important issues.

In order to increase convenience for patients to self-monitor their blood glucose levels, currently many simple and convenient blood glucose detection devices have been developed to provide patients with the ability to regularly self-measure their blood glucose concentration. However, blood glucose measuring devices must be used together with biological test strips in order to carry out measurements of blood glucose concentration. Hence, the cost of biological test strips, wear and tear, detection accuracy, measuring time, and the like, have become enormously important product benchmarks of blood glucose measuring devices.

Currently, widely used carbon ink biological test strips are composed from a conductive silver glue line, conductive carbon ink layer, protective layer, and a biomaterial layer sequentially piled up from the bottom upwards on a substrate. However, the existence of the conductive carbon ink layer compresses the thickness of the conductive silver glue line, which easily results in the carbon ink biological test strip having irregular conductivity, or the occurrence of problems such as excessively low conductivity, moreover, it is difficult to control the detection error value to within ±1 5%. Furthermore, after unsealing the carbon ink biological test strip, the test strip is easily affected with damp, which causes a greater detection error value that impacts detection accuracy.

Hence, in recent years, in order to accommodate market demands for a reduction in test strip size, the electrodes area must also be correspondingly reduced. However, maintaining a definite current response after reducing the electrodes area becomes a significant issue for the design of the electrode material, wherein application of metal electrodes provides an effective means to resolve the issue.

Current methods for manufacturing biological sensing test strips include the following types: 1. Using metal block material and surface treatment. 2. After forming a metallic film on a substrate, using laser etching and definition electrode patterning by means of laser engraving metal technology. Such a method has the advantage of being a mature technology, but has the shortcoming of metal wastage. Moreover, the laser time increases along with the complexity of the patterning. 3. Technologies such as a printed circuit or semiconductor yellow light manufacturing process that requires negative plates or masks to carry out definition electrode patterning, wherein the manufacturing cost is correspondingly expensive, and the manufacturing process is mired in minor details, requiring steps that include applying a light resistant coating, a micro-image manufacturing process, baking, and etching or a lift-off process. Moreover, the same problem of metal wastage still exists.

From the aforementioned description it can be understood that current manufacturing methods of electrochemical biosensor electrode test strips are unable to together provide the advantages of high speed, inexpensive, and with high quality results. Hence, there is still the need for a more economical and simple manufacturing method.

### SUMMARY OF THE INVENTION

In light of the aforementioned shortcomings of the prior art, the primary objective lies in providing a manufacturing method for the simple and convenient manufacturing of test strips provided with metal electrodes.

In order to achieve the aforementioned objective, the manufacturing method of test strip disclosed in the present invention comprises the following steps: providing a substrate, whereby a masking layer is formed on one surface of a substrate; carrying out a patterning manufacturing process, whereby a patterning is formed on the masking layer, and a section covered with the masking layer and an exposed section not covered with the masking layer are formed on the surface of the substrate; forming an ion guide on the surface of the exposed section of the substrate; carrying out a first chemical plating, whereby a first metal layer is formed on the surface of the ion guide; stripping the masking layer, whereby the masking layer is removed from the surface of the substrate; carrying out a second chemical plating, whereby a second metal layer is formed on the surface of the first metal layer, which is used to form a line metal patterning, and thus forming the substrate with a line metal patterning and producing a test strip.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic flow chart of the manufacturing method of the present invention.

FIGS. 2(A)˜(G) are structural schematic views of the manufacturing method of the present invention.

FIG. 3 is an enlarged schematic view of a test strip of the present invention.

FIG. 4 is another enlarged schematic view of the test strip of the present invention.

### DETAILED DESCRIPTION OF THE PREFERRED EMBODIMENTS

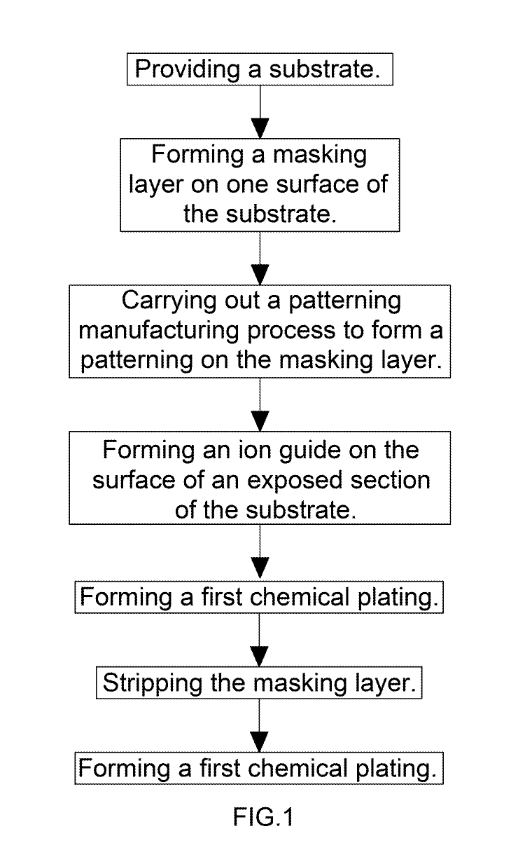

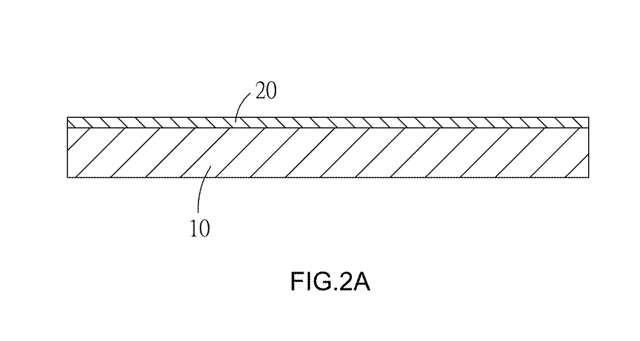

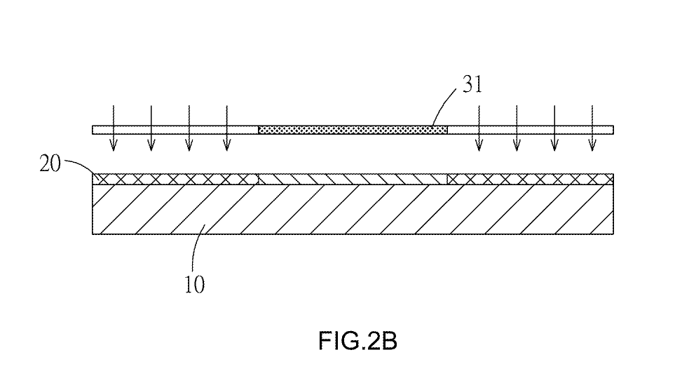

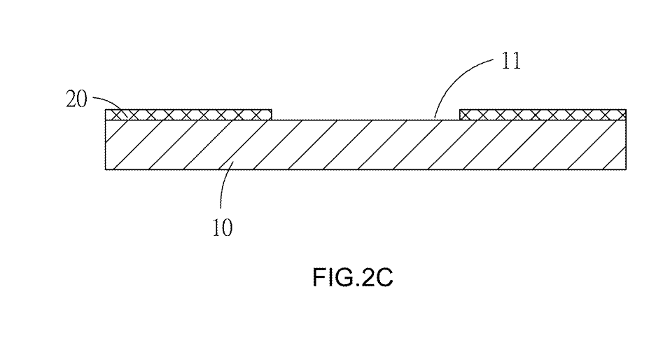

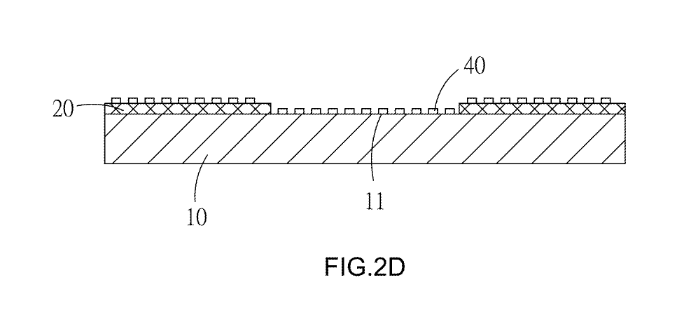

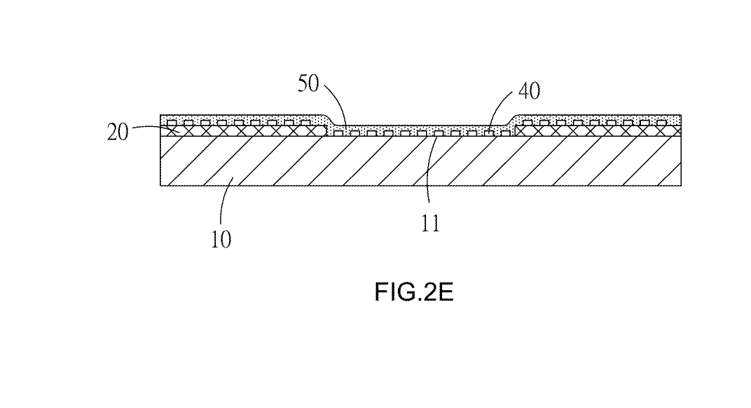

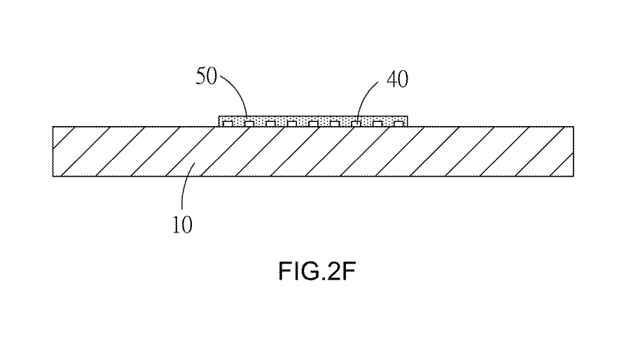

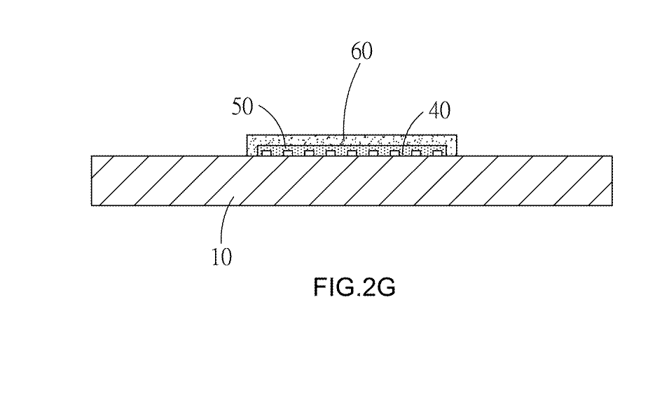

Referring to FIG. 1 and FIGS. 2 (A)˜(G), the manufacturing method of the present invention comprises the following steps:

Providing a substrate 10, wherein the substrate 10 is polyethylene terephthalate (polyethylene terephthalate, PET).

Forming a masking layer 20 on one surface of the substrate 10, wherein a press fit dry film method or a printing wet film method is used to dispose the masking layer 20 on to one surface of the substrate 10.

Carrying out a patterning manufacturing process to achieve patterning on the masking layer 20, wherein a negative film manufacturing process is used to carry out exposure and development, and proceed with the patterning process. As depicted in FIG. 2 (B), providing a mask 31 for placement on the upper side of the masking layer 20. And after carrying out exposure and development, stripping away a predetermined section of the masking layer 20. Finally, as depicted in FIG. 2 (C), forming a section covered with the masking layer 20 and an exposed section 11 not covered with the masking layer 20 on the surface of the substrate 10. As depicted in FIG. 2 (D), forming an ion guide 40 on the surface of the exposed section 11 of the substrate 10, whereby the substrate 10 is immersed in a reactive metal ionic liquid to cause the metal ions to adsorb onto the surface of the exposed section 11 and form the ion guide 40. The reactive metal ions are palladium ions or Group 8 metal ions.

Carrying out a first chemical plating, whereby a first metal layer 50 is formed on the surface of the ion guide 40, as depicted in FIG. 2 (E), wherein the first chemical plating involves placing the substrate 10 in a first chemical plating solution, and using a first chemical method on the ion guide 40 to form the first metal layer 50. The first chemical plating solution comprises chemical compounds of a first metal to be plated used to form the first metal layer, such as chemical compounds including nickel sulfate, succinic acid, sodium dihydrogen hypophosphite, acetic acid, and lactic acid; or chemical compounds such as nickel sulfate, sodium dihydrogen hypophosphite, sodium hydroxide, and acetic acid; or chemical compounds such as nickel sulfate, succinic acid, and lactic acid; wherein the first metal to be plated is nickel.

Stripping the masking layer 20, whereby the masking layer 20 is removed from the surface of the substrate 10, as depicted in FIG. 2 (F), wherein an alkaline bath or an acid bath is used to remove the masking layer 20 as well as the unwanted ion guide 40 and the unwanted first metal layer 50 on the upper side of the substrate 10.

Carrying out a second chemical plating, as depicted in FIG. 2 (G), whereby a second metal layer 60 is formed on the surface of the first metal layer 50, wherein the second chemical plating involves placing the substrate 10 in a second chemical plating solution, and using a second chemical method to form the second metal layer 60 on the first metal layer 50. The second chemical plating solution comprises chemical compounds including a second metal to be plated used to form the second metal layer 60 wherein the second metal to be plated includes at least one of the following metals: gold, silver, copper, nickel, titanium, and palladium. For example, if the second metal to be plated is gold, then the second chemical plating solution can be chemical compounds including a complexing agent and a sulfite and a gold salt, or chemical compounds such as 1-Hydroxy Ethylidene-1,1-Diphosphonic Acid (HEDP) and a gold salt.

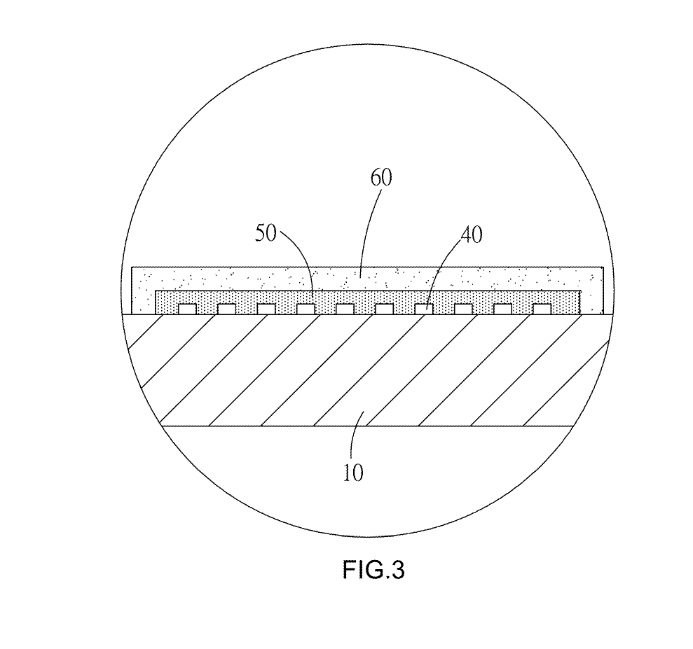

From the completed test strip of the present invention, as depicted in FIG. 3, the outermost second metal layer 60 of the substrate 10 covers the upper surface of the first metal layer 50 and covers the ion guide 40 and the side edges of the first metal layer 50. Moreover, the aforementioned ion guide 40 and the first and second metal layers 50, 60 are used to form a line metal patterning and produce the test strip. Furthermore, the test strip of the present invention is basically a carrier, and therefore any fluid can be tested, including: blood glucose, cholesterol, uric acid, flu, avian flu, enterovirus, pesticide residue, beverage plasticizer, or screening of some heavy metal residues. The deciding factor lies in the choice of enzymes or test fluid and chip circuit design

The present invention uses a multiple chemical plating method to separately cover the substrate 10, whereby, the first metal layer 50 is used to define a position area for a line metal patterning, and then the second metal layer 60 is directly attached to the position area to form the line metal patterning, thereby reducing wastage of the second metal layer 60, especially as the second metal layer 60 is commonly made from relatively expensive and high conducting material such as gold material, and hence reduces cost. Moreover, using a chemical plating method also simplifies the manufacturing process. Furthermore, in the line metal patterning described in the present invention, the ion guide 40 lies between the substrate 10 and the first metal layer 50, thereby enabling a more tight joining between the two. And the first metal layer 50 lies between the ion guide 40 and the second metal layer 60, which further more easily enables the reactively stable second metal layer 60 (such as gold or palladium) to be disposed on the first metal layer 50 through chemical plating. And, using the second metal layer 60 (such as gold or palladium) to act as an electrode enables more accurate measurements of digital data compared to using an electrode made from carbon or silver of the prior art.

In the manufacturing process described above, the substrate 10 can be placed in a pre-infusion after forming the masking layer 20 thereon to provide the surface of the substrate 10 with a potential difference that helps in attaching the ion guide 40. The pre-infusion can be a chemical compound such as sodium bisulfate, or can be hydrogen sulfide and sulfuric acid. And after forming the ion guide 40 on the surface of the exposed section of the substrate 10, the substrate 10 can be further immersed in a reducing agent, thereby metalizing and reducing the ion guide 40 to a metal guide. For example, metallization of palladium ions or Group 8 metal ions reduces the metal ions to palladium metal or Group 8 metal respectively using a reducing agent such as fluoroboric acid or dimethylamine-borane.

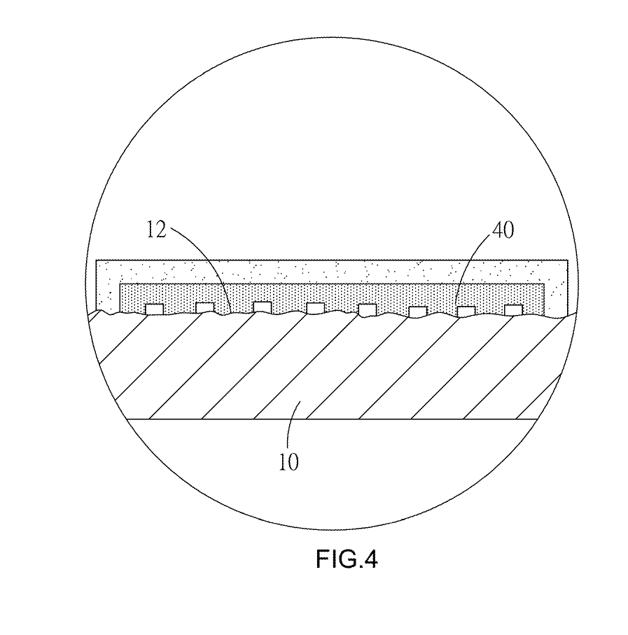

In addition, the substrate 10 can be provided with a modified surface 12, as shown in FIG. 4 that depicts another embodiment of the present invention, and the masking layer (not shown in the drawings) is disposed on the modified surface 12, which enables follow-up installation of the ion guide 40 on the modified surface 12. The modified surface 12 improves attachment of the ion guide 40 on the substrate 10. As depicted in the drawing of the embodiment, it is understood that the modified surface 12 can be a structure provided with a plurality of depressions and protuberances, wherein the modified surface 12 is formed on the surface of the substrate 10 using chemical or physical methods, such as using a surface modifier on the surface of the substrate 10 to achieve surface modification and form the modified surface 12, wherein the surface modifier can be diethylene glycol monobutyl ether or can be a compound of diethylene glycol monobutyl ether and ethylene glycol. And after surface modification of the aforementioned substrate 10, a cleaning step is carried out to clean the surface of the substrate 10, wherein the cleaning step uses a conditioner to clean the surface of the the substrate 10. The conditioner can be sulfuric acid or glyoxal or can be a compound of glyoxal and ethylene glycol.

In conclusion, the present invention provides a preferred practical manufacturing method for a test strip. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A manufacturing method of test strip, comprising the following steps:
a) providing a substrate;
b) forming a masking layer on one surface of the substrate;
c) carrying out a patterning manufacturing process to form a patterning on the masking layer, whereby a section covered with the masking layer and an exposed section not covered with the masking layer is formed on the surface of the substrate;
d) forming an ion guide on the surface of the exposed section of the substrate;
e) carrying out a first chemical plating, whereby a first metal layer is formed on the surface of the ion guide;
f) stripping the masking layer, whereby the masking layer is removed from the surface of the substrate; and
g) carrying out a second chemical plating, whereby a second metal layer is formed on the surface of the first metal layer.

2. The manufacturing method of test strip according to claim 1, wherein the substrate is provided with a modified surface, and the masking layer is disposed on the modified surface.

3. The manufacturing method of test strip according to claim 2, wherein a surface modifier is used to carry out surface modification of the surface of the substrate to form the modified surface.

4. The manufacturing method of test strip according to claim 1, wherein a press fit dry film method or printing wet film method is used to dispose the masking layer on one surface of the substrate.

5. The manufacturing method of test strip according to claim 1, wherein the patterning manufacturing process is achieved through a negative film manufacturing process that carries out exposure and development.

6. The manufacturing method of test strip according to claim 1, wherein the substrate is immersed in a reactive metal ionic liquid to cause the metal ions to adsorb onto the surface of the exposed section and form the ion guide.

7. The manufacturing method of test strip according to claim 6, wherein the reactive metal ions are palladium ions or Group 8 metal ions.

8. The manufacturing method of test strip according to claim 1, wherein the first chemical plating involves placing the substrate in a first chemical plating solution, and using a first chemical method to form the first metal layer on the ion guide, wherein the first chemical plating solution comprises chemical compounds of a first metal to be plated used to form the first metal layer; wherein the first metal to be plated is nickel.

9. The manufacturing method of test strip according to claim 1, wherein the second chemical plating involves placing the substrate in a second chemical plating solution, and using a second chemical method to form the second metal layer on the first metal layer, wherein the second chemical plating solution comprises chemical compounds of a second metal to be plated used to form the second metal layer; wherein the second metal to be plated is at least one of the following metals: gold, silver, copper, nickel, titanium, and palladium.

10. The manufacturing method of test strip according to claim 1, wherein the substrate is polyethylene terephthalate (polyethylene terephthalate, PET).

11. A manufacturing method of test strip, comprising the following steps:
a) providing a substrate, and providing the substrate with a modified surface;
b) forming a masking layer on the modified surface of the substrate;
c) carrying out a patterning manufacturing process to form a patterning on the masking layer, whereby a section covered with the masking layer and an exposed section not covered with the masking layer is formed on the surface of the substrate;
d) forming an ion guide on the surface of the exposed section of the substrate, whereby the substrate is immersed in a reactive metal ionic liquid to cause the metal ions to adsorb onto the surface of the exposed section and form the ion guide; the reactive metal ions being palladium ions or Group 8 metal ions;
e) carrying out a first chemical plating, whereby the substrate is placed in a first chemical plating solution, and a first chemical method is used to form a first metal layer on the ion guide, wherein the first chemical plating solution comprises chemical compounds of a first metal to be plated used to form the first metal layer; wherein the first metal to be plated is nickel.
f) stripping the masking layer, whereby the masking layer is removed from the surface of the substrate; and
g) carrying out a second chemical plating, whereby the substrate is placed in a second chemical plating solution, and a second chemical method is used to form a second metal layer on the first metal layer, wherein the second chemical plating solution comprises chemical compounds of a second metal to be plated used to form the second metal layer; wherein the second metal to be plated is at least one of the following metals: gold, silver, copper, nickel, titanium, and palladium.
